(19) United States
(12) Patent Application Publication
(10) Pub. No.: US 2019/0379010 A1
(43) Pub. Date: Dec. 12, 2019

(54) FLEXIBLE BATTERIES

(71) Applicant: CYBERX Engineering Inc., Wilmington, DE (US)

(72) Inventors: Kirill Khaliuta, Saint Petersburg (RU); Sergei Belov, Saint Petersburg (RU); Stanislav Komissarov, Saint Petersburg (RU); Timofei Kotsiubinskii, Saint Petersburg (RU)

(21) Appl. No.: 16/283,794

(22) Filed: Feb. 24, 2019

Related U.S. Application Data
(62) Division of application No. 16/045,226, filed on Jul. 25, 2018.
Application No. 16/045,226 is a continuation-in-part of application No. 16/003,211, filed on Jun. 8, 2018, now Pat. No. 10,201,195.

(51) Int. Cl. H01M 2/02; H01M 2/16; H01M 10/26; H01M 4/62; H01M 4/36; H01M 4/04; H01M 4/38; H01M 10/28; H01M 4/48

(52) U.S. Cl. CPC H01M 2/0275; H01M 2/1686; H01M 10/26; H01M 4/622; H01M 4/364; H01M 2300/0014; H01M 4/38; H01M 4/0414; H01M 2/1653; H01M 10/28; H01M 4/48; H01M 4/0411

(57) ABSTRACT

A flexible battery and method of manufacturing thereof are provided. An example flexible battery may include a first current collector comprising a first copper plate, an anode layer disposed on the first current collector, a second current collector comprising a second copper plate, a cathode layer disposed on the second current collector, and a separator layer comprising a polymer material. The anode layer may comprise a composite of thermoplastics, silver powder, and potassium hydrogen carbonate. The cathode layer may comprise a composite of thermoplastics and a freshly prepared zinc hydroxide. The separator layer can be impregnated with an electrolyte comprising an aqueous solution of potassium hydroxide, lithium hydroxide, potassium zincate, and modifying additives. The modifying additives may include a monobasic organic acid, a dibasic organic acid, and a tribasic organic acid as anion donors, and one or more complexones as cation electron acceptors.

### CROSS-REFERENCE TO RELATED APPLICATIONS

This application is a divisional application of U.S. application Ser. No. 16/045,226, entitled “FLEXIBLE BATTERIES”, filed on Jul. 25, 2018, which is a Continuation-In-Part of U.S. patent application Ser. No. 16/003,211, titled “Heating System for Heated Clothing,” filed Jun. 8, 2018. The subject matter of the aforementioned applications is incorporated herein by reference for all purposes.

### TECHNICAL FIELD

This disclosure generally relates to batteries. More specifically, this disclosure relates to flexible batteries and methods of manufacturing flexible batteries.

### BACKGROUND

Flexible batteries can be used in various applications. For example, the flexible batteries may be used to provide electricity to electrically-heated clothing used in sport activities, outdoor activities, and while performing outdoor work in a cold weather. To these ends, it is desirable to use a rechargeable flexible battery that can be placed inside electrically-heated clothing. However, to be used with the electrically-heated clothing, the flexible batteries are required to have an extended shelf life, extended cycle life, be compact, have a short charging time, and operate at very low temperatures without losing energy capacity. Current flexible batteries do not provide such characteristics. Additionally, current flexible batteries may not be useful in clothing since they may release gas during operation and suffer from formation of dendrites leading to short circuits.

### SUMMARY

This section introduces a selection of concepts in a simplified form that are further described in the Detailed Description section, below. This summary does not identify key or essential features of the claimed subject matter and is not intended to be an aid in determining the scope of the claimed subject matter.

This disclosure is generally concerned with flexible batteries and manufacturing of flexible batteries. The present technology may provide flexible batteries to be used in electrically-heated clothing and in an extensive range of environment conditions.

According to one embodiment of this disclosure, a method for manufacturing of a flexible battery is provided. The method may include providing a first current collector. The first current collector may include a first plate made from a first metal material. The method may include disposing an anode layer on the first current collector. The anode layer may comprise an anode active mass. The anode active mass may include substantially a silver. The method may include providing a second current collector. The second current collector may include a second plate made from a second metal material. The method may further include disposing a cathode layer on the second current collector. The cathode layer may include a cathode active mass. The cathode active mass may include a zinc hydroxide. The method may further include disposing a separator layer between the anode layer and the cathode layer. The separator layer may include a polymer material. The method may further include joining, substantially parallel to each other, the first current collector, the anode layer, the separator layer, the cathode layer, and the second current collector to obtain a multi-layer structure. The method may include impregnating the separator layer with an electrolyte. The method may further include laminating the multi-layer structure with a polypropylene shell.

The separator layer may include a microfiber polymer layer of 100 micrometers of width. Joining the layers may include silk screen printing an adhesive on a first surface of the separator layer and a second surface of the separator layer and gluing the separator layer by the first surface to the anode layer and by the second surface to the cathode layer. The adhesive may include an epoxy polyurethane two-component polymer.

Disposing the anode layer may include silk screen printing the anode active mass on a first surface of the first current collector. The anode active mass can be also disposed on the first current collector using slot-die coating. A second surface of the first current collector can be covered with an epoxy polyurethane two-component polymer to protect the first current collector from contact with an electrolyte. Disposing the cathode layer may include silk screen printing the cathode active mass on a first surface of the second current collector. The cathode active mass can be also disposed on the second current collector using slot-die coating. The cathode layer can be disposed on a first surface of the second current collector. A second surface of the second current collector can be covered with the epoxy polyurethane two-component polymer to protect the second current collector from contact with an electrolyte.

The anode active mass may include a mixture of a composite of thermoplastics, a silver powder comprising silver particles of between 10⁻⁹ to 10⁻⁶ meters in a diameter, and a potassium hydrogen carbonate of 10% by weight of the silver powder. The cathode active mass can include a mixture of a composite of thermoplastics and a freshly prepared zinc hydroxide. The composite of thermoplastics may include a mixture of a low-density polyethylene and a polyethylene vinyl acetate.

The electrolyte may include a mixture of 30-40% aqueous solution of potassium hydroxide, 1.5-2% aqueous solution of lithium hydroxide, 4-8% aqueous solution of potassium zincate, and 0.8-1.2% aqueous solution of modifying additives. The modifying additives may include one or more of a monobasic organic acid, a dibasic organic acid, and a tribasic organic acid as anion donors. The modifying additives may further include one or more complexones as cation electron acceptors.

The method may further include, while providing the second current collector, making one or more through holes in the second current collector to allow the electrolyte to penetrate to the separator layer. Impregnating the separator layer may include disposing the multi-layered structure into a surface-active agent (SAG) within a first vacuum container to allow the SAG to seal the one or more through holes in the second current collector. Impregnating the separator layer may further include disposing the multi-layered structure into the electrolyte within a second vacuum container until the SAG is evaporated and the separator layer is filled with the electrolyte. After impregnating the separator layer, the one or more through holes in the second current collector can be sealed.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 shows elements of a flexible battery, according to some example embodiments of the present disclosure.

FIG. 2 is a flow chart showing steps of a method for manufacturing a flexible battery, according to an example embodiment of the present disclosure.

FIG. 3 shows elements disposed on a current collector of a flexible battery, according to an example embodiment.

FIG. 4 shows example flexible batteries of different shapes, according to various example embodiments of the present disclosure.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Embodiments of this disclosure are concerned with flexible batteries and methods of manufacturing of heated batteries. Embodiments of the present disclosure may provide the flexible batteries for use with electrically-heated clothing in an extensive range of environmental conditions. In flexible batteries of the present disclosure, a silver-based material can be used for an anode layer and zinc can be used for cathode layer. Use of zinc for the cathode layer may allow an increase of capacity of the flexible batteries. The anode layer and cathode layer can be disposed on current collectors using silk screen printing. Additives to an electrolyte used in the flexible batteries disclosed herein allow prevention of formation of zinc dendrites in the cathode layer, and by doing so to extend a lifetime of the flexible batteries. The technology described herein also allows prevention of release of a gas (which is a known issue for all zinc-silver batteries) during operations of the flexible batteries.

According to an example embodiment, a method for manufacturing of a flexible battery may include providing a first current collector. The first current collector may include a first plate made from a first metal material. The method may further include disposing an anode layer on the first current collector. The anode layer may include an anode active mass. The anode active mass may include substantially a silver. The method may include providing a second current collector. The second current collector may include a second plate made from a second metal material. The method may further include disposing a cathode layer on the second current collector. The cathode layer may include a cathode active mass. The cathode active mass may include a zinc hydroxide. The method may include disposing a separator layer between the anode layer and the cathode layer. The separator layer may include a polymer material. The method may further include joining, substantially parallel to each other, the first current collector, the anode layer, the separator layer, the cathode layer, and the second current collector to obtain a multi-layer structure. The method may further include impregnating the separator layer with an electrolyte. The method may further include laminating the multi-layer structure with a polypropylene shell.

Referring now to the drawings, exemplary embodiments are described. The drawings are schematic illustrations of idealized example embodiments. Thus, the example embodiments discussed herein should not be construed as limited to the particular illustrations presented herein, rather these example embodiments can include deviations and differ from the illustrations presented herein.

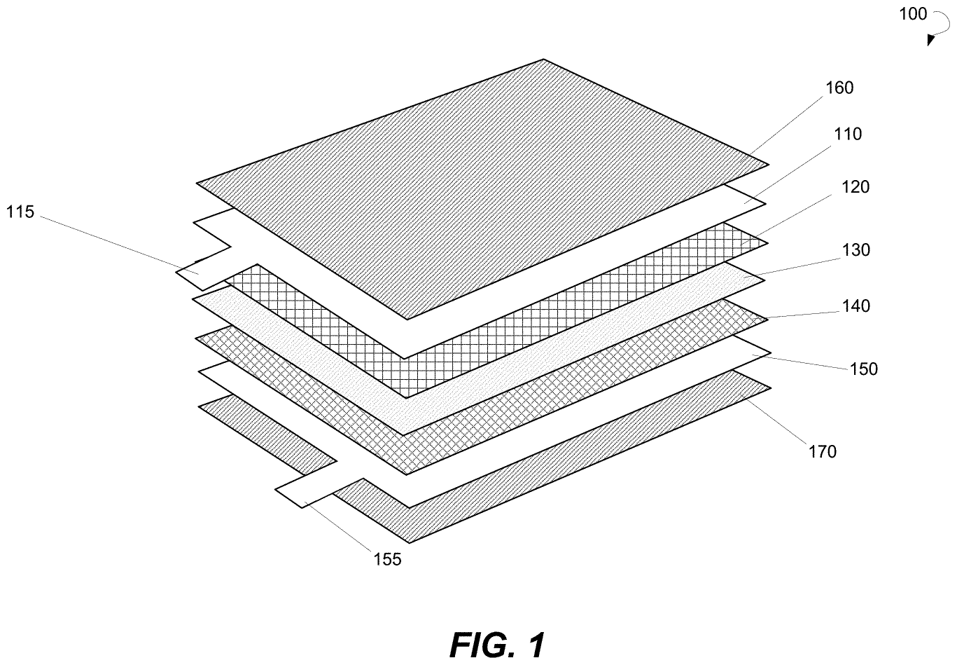

FIG. 1 shows basic elements of a flexible battery 100, according to some embodiments of the present disclosure. The flexible battery 100 may include a first current collector 110, an anode layer 120, a separator 130, a cathode layer 140, and a second current collector 150. The first current collector may include terminal 115. The second current collector may include terminal 155. The flexible battery 100 may be laminated with a shell. The shell may be made of a polypropylene. The shell may include a first side 160 and a second side 170.

### Current Collectors

In some embodiments, the first current collector 110 can include a copper plate. The copper plate can be made of oxygen-free copper. The oxygen-free copper is a high conductivity copper typically used in microelectronics. Prior to being used as the first current collector 110, the copper plate can be prepared using the following process. The copper plate can be etched for a short period by 10% nitic acid aqueous solution to remove oxygen film. Then the copper plate can be washed using deionized water. Further, the copper plate can be coated with a silver by placing the copper plate into a solution for chemical silvering. The solution for the chemical silvering may include a mixture of 40 by a volume unit of 5% aqueous solution of silver nitrate (AgNO₃) and 1 by the volume unit of 25% aqueous solution of ammonia (NH₃). 1-5 micrometers of silver layer can be further disposed on the copper plate using an electrochemical deposition at a current density of 0.8-1 ampere per square decimeter. The silver-coated copper plate can be further washed using deionized water and dried by compressed or warm filtered air. After being silver-coated, the copper plate can be further coated with a platinum layer of 1-2 micrometers using platinum galvanization. The platinum galvanization can be performed using an electrolyte for platinum galvanization and a platinum anode or an iridium anode. The platinum galvanization can be carried out during 15-20 minutes at temperature of the electrolyte at 60-70 degrees Celsius and current density of 0.1 ampere per square decimeter.

Similarly, the second current collector 150 may include a copper plate made of oxygen-free copper. Prior to being used as the second current collector 150, the copper plate can be prepared by the following process. The copper plate can be etched for a short period by 10% aqueous solution of nitic acid to remove oxygen film. Then the copper plate can be further washed using deionized water. Further, the process may include making 1 to 5 through holes in the copper plate. The through holes can be further used for impregnating the separator layer 130 with an electrolyte at a step of manufacturing a flexible battery. To prevent contact with the electrolyte, the copper plate can be further coated with a zinc layer of 1-2 micrometers using zinc galvanization. The zinc galvanization can be performed using a zinc anode and the same electrolyte as for impregnating the separator layer 130. The zinc galvanization can be carried out at room temperature of the electrolyte and current density of 2-3 ampere per square decimeter. After being zinc coated, the copper plate can be further washed using deionized water and dried by compressed or warm filtered air.

### Separator Layers and Electrolyte

In some embodiments, the separator layer 130 may include microfiber polypropylene. The thickness of the separator layer can be 100 micrometers. The separator layer 130 can be impregnated with an electrolyte. In some embodiments, the electrolyte can include a mixture of 30-40% aqueous solution of potassium hydroxide, 1.5-2% aqueous solution of lithium hydroxide, 4-8% aqueous solution of potassium zincate, and 0.8-1.2% aqueous solution of modifying additives. The modifying additives may include one or more of a monobasic organic acid, a dibasic organic acid, and a tribasic organic acid to be used as anion donors. The modifying additives may also include one or more complexones to be used as cation electron acceptors. To remove dissolved gases, the electrolyte can be vacuumed during 3-5 minutes at pressure of saturated vapor of the electrolyte (about 10 millimeters of mercury).

In one example embodiment, the process of manufacturing the electrolyte can include admixing 200 grams of potassium hydroxide (KOH), 2 grams of lithium hydroxide (LiOH), and 25 grams of zinc oxide (ZnO) to 400-410 grams of water (H₂0). The obtained mixture can be blended intensively at a temperature of 100-110 degrees Celsius. The mixture can be further allowed to cool down. The process may further include, while blending, adding 6.0-6.3 grams of formic acid (HCOOH) and 1.0-1.24 grams of ethylenediaminetetraacetic acid disodium salt (C₁₀H₁₄N₂Na₂O₈) to the mixture. After all components are dissolved, the mixture can be degassed for 3-5 minutes using a vacuum filtration system.

In another example embodiment, the process of manufacturing the electrolyte can include admixing 200 grams of potassium hydroxide (KOH), 2 grams of lithium hydroxide (LiOH), and 25 grams of zinc oxide (ZnO) to 400-410 grams of water (H₂0). The obtained mixture can be blended intensively at a temperature of 100-110 degrees Celsius. The mixture can be then allowed to cool down. The process may further include, while blending, adding 13-14 grams of formic acid (HCOOH) and 30-35 grams of dimethyl sulfoxide (C₂H₆SO) to the mixture. After all components are dissolved, the mixture can be degassed for 3-5 minutes using a vacuum filtration system.

### Anode Active Mass

In some embodiments, the anode layer 120 may include an anode active mass. To form the anode layer 120, the anode active mass can be disposed on the first current collector by silk screen printing. The anode active mass may include a silver-organic composite that is based on a composite of thermoplastic polymers. The anode active mass may include a composite of thermoplastics, silver powder, and zinc hydroxide (ZnOH) of 5-10% by weight of the silver powder. The zinc hydroxide can be added to anode active mass to improve effectiveness of forming charge/discharge cycles.

Particles of the silver powder used in the anode active mass can be of 10⁻⁹ to 10⁻⁶ in a diameter. The silver powder may include a dispersion of silver nanocrystals and silver microcrystals. To obtain the silver powder, a soluble silver salt can be converted to a dispersion of silver salt nanocrystals or silver salt microcrystals. The dispersion can further be washed and used to obtain the silver powder by a reduction process.

In an example embodiment, the process of manufacturing the silver powder may include admixing 3-5% aqueous solution of hydrogen chloride (HCl) to 3-5% aqueous solution of silver nitrate (AgNO₃) to obtain silver chloride (AgCl) precipitate. The silver chloride precipitate can be further separated and washed by deionized water. The dispersion of silver chloride can be further reduced to the silver to obtain metallic silver by using strong reducing agents, such as hydrazine or sodium borohydride. For example, 1-1.2 grams of 10% sodium borohydride (NaBH₄) can be added to a suspension of 8 grams of silver chloride to obtain silver precipitate. The silver precipitate can be further separated and washed multiple times (6-8 times) by deionized water. The obtained silver powder can be further dried.

In another example embodiment, the process of manufacturing the silver powder may include admixing, at a room temperature, 5-10% of aqueous solution of sodium borohydride (NaBH₄) to 2-3% aqueous solution of silver nitrate (AgNO₃) to obtain silver precipitate. The received mixture can be further blended until the process of reduction of silver is finished. The process of reduction of silver is finished when the process of release of a gas is substantially finished. The silver participate can be further separated and washed multiple times (6-8 times) by deionized water. The obtained silver powder can be further dried at a temperature of 130-150 degrees Celsius.

In one example embodiment, the anode active mass can be prepared by the following process. A polyethylene vinyl acetate (PEVA) can be dissolved in 5 grams of a mixture of aliphatic hydrocarbons and aromatic hydrocarbons, for example, white spirit (nefras C4-155/200), at a temperature of 50-60 degrees Celsius. Silver powder and zinc hydroxide can be further added to the solution of PEVA. The received mixture can be further blended until a homogeneous mass is formed.

In another example embodiments, the anode active mass can be prepared by the following process. A mixture of 5 grams of a low-density polyethylene (PE-LD) and 1 gram of PEVA can be dissolved in 40 grams of a mixture of aliphatic hydrocarbons and aromatic hydrocarbons, for example, white spirit (nefras C4-155/200), at a temperature of 50-60 degrees Celsius. Silver powder and zinc hydroxide can be further added to the solution of PE-LD and PEVA. The received mixture can be further blended until a homogeneous mass is formed.

In some embodiments, the silver powder can be encapsulated with potassium hydrogen carbonate (KHCO₃) to improve functionality of the silver in silver-organic composite. For example, 1 gram of the silver powder can be moistened with 0.5 gram of 20% aqueous solution of potassium hydrogen carbonate to obtain a paste. The obtained paste can be further dried at a temperature of 110-130 degrees of Celsius. The paste can be further fractioned into a powder.

### Cathode Active Mass

In some embodiments, the cathode layer 140 may include a cathode active mass. The cathode active mass may include a mixture of freshly prepared zinc hydroxide (Zn(OH)₂) and a composite of thermoplastic polymers. The composite of thermoplastics used for preparation of cathode active mass can be the same composite of thermoplastics as used for anode active mass. The ratio of mass of the zinc hydroxide in the cathode anode mass to mass of silver in the anode active mass can be 1 to 1.

In some embodiments, the process of manufacturing of zinc hydroxide may include admixing, 416 grams of 10% aqueous solution of potassium hydroxide to 500 grams of 10% aqueous solution of zinc chloride (ZnCl₂). The obtained mixture can be further blended to obtain a zinc hydroxide precipitate. The zinc hydroxide precipitate can be further separated and washed multiple times (6-8 times) with deionized water. The zinc hydroxide precipitate can be then dried.

### Manufacture of a Flexible Battery

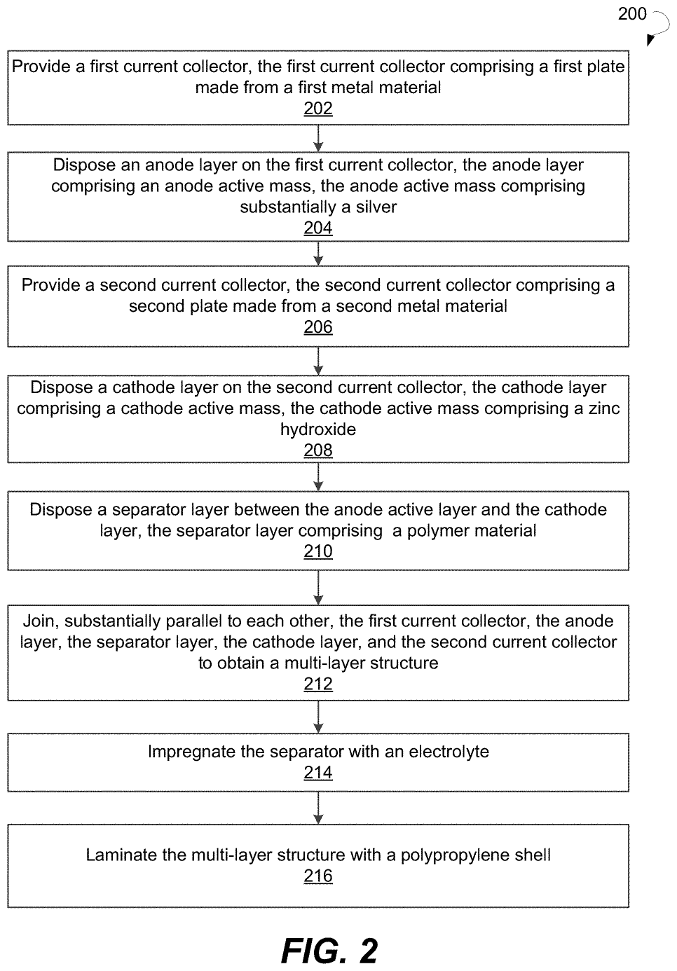

FIG. 2 is a flow chart showing a method 200 for manufacturing of a flexible battery according to some example embodiments.

In block 202, the method 200 may commence with providing a first current collector. The first current collector may include a first plate made from a first metal material. Specifically, the first current collector can be made of copper plate coated with a silver layer and a platinum layer.

In block 204, the method 200 may include disposing an anode layer on the first current collector. The anode layer may include an anode active mass, with the anode active mass comprising substantially a silver. Specifically, the anode active mass can be a silver-organic composite based on a mixture of thermoplastics. The silver powder may comprise silver particles of between 10⁻⁹ to 10⁻⁶ meters in a diameter, and a zinc hydroxide of 5 to 10% by weight of the silver powder.

In one embodiment, to form the anode layer, the anode active mass can be silk screen printed on the first current collector. In another embodiment, the anode active mass can be disposed on the first current collector using slot-die coating. Prior to the disposing the anode layer, the method 200 may include disposing a first frame on the first current collector to provide first boundaries. The anode layer can be disposed within the first boundaries. The first frame can be made by silk screen printing of an epoxy polyurethane two-component polymer on the first current collector. After disposing the anode active mass on the first current collector, the anode layer can be dried at temperature 90-110 degrees of Celsius. The anode layer can be further compressed. For example, the anode layer can be covered with a cellophane film and flattened with a roller at temperature 150-165 degrees Celsius.

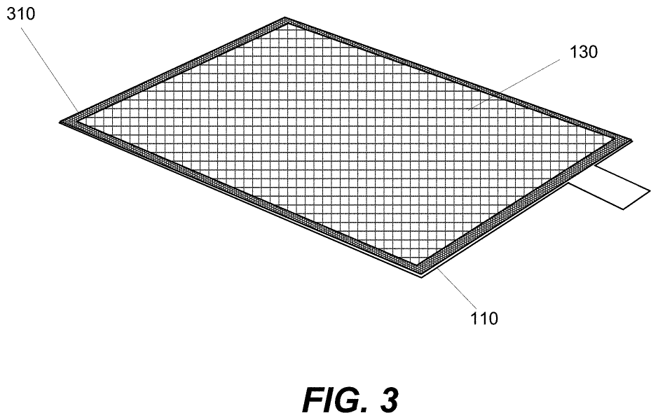

FIG. 3 shows elements disposed on the first current collector 110 of a flexible battery, according to an example embodiment. The anode active mass 130 can be silk screen printed on the first current collector 120 within boundaries formed by the first frame 310 disposed on the first current collector 110.

Referring back to FIG. 2, in block 206, the method 200 may further include providing a second current collector. The second current collector may include a second plate made from a second metal material. In one example embodiment, the second current collector can be made of a copper plate coated with a zinc layer. Prior to being zinc coated, one or more through holes can be made in the copper plate. The through holes can further allow an electrolyte to penetrate to a separator layer.

In block 208, the method 200 may include disposing a cathode layer on the second current collector. The cathode layer may include a cathode active mass. The cathode active mass may include a mixture of freshly prepared zinc hydroxide and a composite of thermoplastics. In one embodiments, the cathode active mass can be silk screen printed on one surface of the second current collector. In another embodiment, the cathode active mass can be disposed on the second current collector using a slot-die coating. Prior to disposing the cathode layer, the method 200 may include disposing a second frame on the second current collector to provide second boundaries. The cathode layer can be disposed on the second current collector with the second boundaries. The second frame can be made by silk screen printing of an epoxy polyurethane two-component polymer on the second current collector. After disposing the cathode active mass on the second current collector, the anode layer can be dried at temperature of 90-110 degrees of Celsius. The cathode layer can be further compressed. For example, the cathode layer can be covered with a cellophane film and flattened with a roller at temperature 150-165 degrees Celsius.

In block 210, the method 200 may further include disposing a separator layer between the anode layer the cathode layer. The separator layer may include a polymer material. In one embodiment, the separator layer can include a microfiber polymer layer of 100 micrometers of width. In another embodiment, the separator layer may include a cellophane film impregnated with an electrolyte.

In block 212, the method 200 may further include joining, substantially parallel to each other, the first current collector, the anode layer, the separator layer, the cathode layer, and the second current collector to obtain a multi-layer structure. The joining may include gluing, using an adhesive, the separator layer, by a first surface, to the anode layer, and, by a second surface, to the cathode layer. Prior to joining, the adhesive can be silk screen printed on the first surface and the second surface of the separator layer, the anode layer, and the cathode layer. The adhesive may include epoxy polyurethane two-component polymer. Prior to joining, the surface of the first current collector opposite the surface contacting the anode layer can be covered with epoxy polyurethane two-component polymer to prevent contact between copper material of the first current collector and the electrolyte. Similarly, the surface of the second current collector opposite the surface contacting the cathode layer can be covered with epoxy polyurethane two-component polymer to prevent contact between copper material of the second current collector and the electrolyte. Prior to joining, the terminal 115 of the first current collector 110 and the terminal 155 of the second current collector 150 can be covered with PEVA for sealing.

In block 214, the method 200 may further include impregnating the separator layer with an electrolyte. Impregnating may include two operations. At a first operation, the multi-layered structure can be disposed in a surface-active agent (SAG) within a first vacuum container to allow the SAG to seal the through holes in the second current collector. At a second operation, the multi-layered structure can be further kept disposed into the electrolyte within a second vacuum container until the SAG is evaporated and the separator layer is filled with the electrolyte. After the separator layer is filled with the electrolyte, the through holes in the second current collector can be sealed. The sealing of the through holes can be carried out by gluing, vulcanization, or filling with fast curing polymers.

The electrolyte may include a mixture of 30-40% aqueous solution of potassium hydroxide, 1.5-2% aqueous solution of lithium hydroxide, 4-8% aqueous solution of potassium zincate, and 0.8-1.2% aqueous solution of modifying additives. The modifying additives may include a monobasic organic acid, a dibasic organic acid, and a tribasic organic acid as anion donors. The modifying additives may further include one or more complexones as cation electron acceptors.

In block 216, the method 200 may further include laminating the multi-layer structure with a polypropylene shell. The purpose of the polypropylene shell is to prevent leaking of the electrolyte out of the flexible battery. In some embodiments, a hole can be made in the propylene shell to allow for filling interior of the flexible battery with an additional portion of electrolyte. The electrolyte can be filled by disposing the laminated flexible battery into the electrolyte within a vacuum container. After the interior of the flexible battery is filled with the electrolyte, the hole in the propylene shell can be sealed.

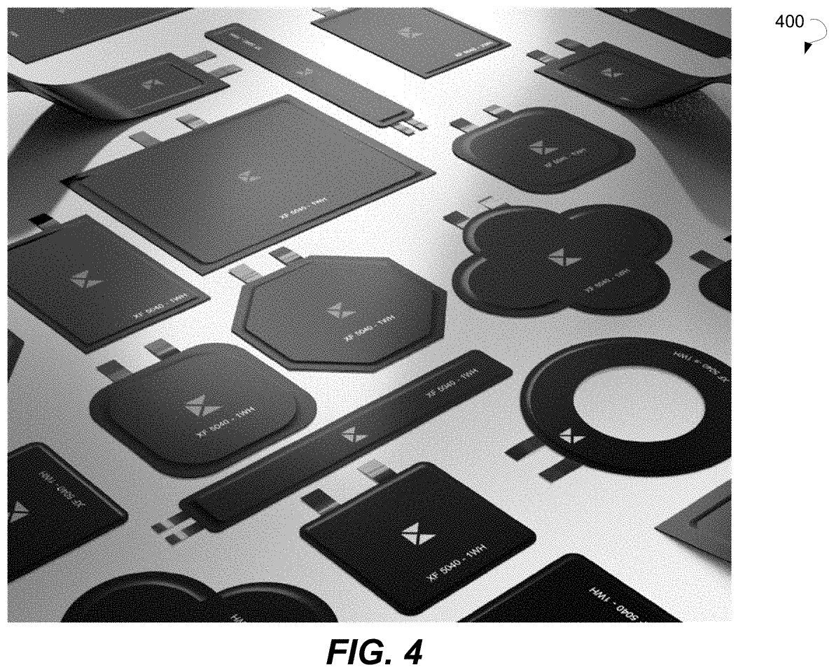

The flexible battery can be determined by shape of the first current layer and the second current layer. The size and shape of the flexible batteries may depend on applications wherein the battery is used. The size and shape of the flexible batteries may depend on a type of heated clothing in which the flexible battery will be disposed. The flexible battery may be of any basic geometric shape, such a rectangle, a square, a circle, a ring, or a combination of basic geometrical shapes. FIG. 4 shows various example flexible batteries of different shapes.

### Characteristics of the Flexible Battery Disclosed Herein

Table 1 shows a comparison of basic characteristics of flexible batteries disclosed in the present disclosure and currently used batteries.

TABLE 1

| | | | | Minimum | |
|---|---|---|---|---|---|
| | Specific | Energy | | Charge/ | |
| | Energy | Density | Cycle | Discharger | Shelf |
| Battery Type | Wh/kg | Wh/liter | Life | Temperature | Life |
| Disclosed herein | 300 | 1000 | 1500 | −50° C. | unlimited |
| Prior art Ag/Zn | 150 | 550 | 150 | −50° C. | unlimited |
| Li-Polymer | 250 | 600 | 600 | −10° C. | 3 years |
| Li-ion | 200 | 400 | 400 | −10° C. | 3 years |
| Ni-MH | 70 | 150 | 1000 | −30° C. | 3 years |
| Ni—Cd | 65 | 200 | 2000 | −50° C. | 3 years |

One advantage of the flexible batteries disclosed herein is that the they do not release gas during operations, while currently available conventional zinc-silver batteries do. Additives to the electrolyte used in the flexible batteries disclosed herein may facilitate preventing formation of zinc dendrites in the cathode layer. This may help to prevent short circuits in the flexible batteries and, hence, to increase life of the battery.

Because zinc is used for the cathode layer, an energy density of the flexible batteries disclosed herein may exceed 1 Kilowatts per liter. An energy density of current flexible batteries does not exceed 1000-watts per liter. For comparison, an energy density of regular rigid batteries does not exceed 1.2 kilowatts per liter. C-rate of the flexible batteries disclosed herein, that is rate at which the flexible battery is discharged relative to its maximum capacity, can be at level of 100C.

Cycle life of the flexible batteries disclosed herein may be 1500, which is 10 times more than the cycle life of current zinc-silver batteries.

A charging time of the flexible batteries disclosed herein does not exceed 30 minutes. A charging time of current zinc-silver batteries is 5-6 hours.

The flexible batteries disclosed herein may provide more stable voltage as compared to current zinc-silver batteries. Characteristics of the flexible batteries disclosed herein do not degrade rapidly at low temperature below the freezing point. For example, at the temperature −40 degrees Celsius, the capacity of battery may drop by no more than 21%.

Thus, the flexible battery and method of manufacturing thereof have been described. Although embodiments have been described with reference to specific example embodiments, it will be evident that various modifications and changes can be made to these example embodiments without departing from the broader spirit and scope of the present document. Accordingly, the specification and drawings are to be regarded in an illustrative rather than a restrictive sense.

What is claimed is:

1. A method for manufacturing of a flexible battery, the method comprising:
providing a first current collector, the first current collector comprising a first plate made from a first metal material;
disposing an anode layer on the first current collector, the anode layer comprising an anode active mass, the anode active mass comprising substantially a silver;
providing a second current collector, second current collector comprising a second plate made from a second metal material;
disposing a cathode layer on the second current collector, the cathode layer comprising a cathode active mass, the cathode active mass comprising substantially a zinc hydroxide;
disposing a separator layer between the anode layer and the cathode layer, the separator layer comprising a polymer material;
joining, substantially parallel to each other, the first current collector, the anode layer, the separator layer, the cathode layer, and the second current collector to obtain a multi-layer structure;
impregnating the separator layer with an electrolyte; and
laminating the multi-layer structure with a polypropylene shell.

2. The method of claim 1, wherein the separator layer includes a microfiber polymer layer of 100 micrometers of width.

3. The method of claim 1, wherein the separator layer includes a cellophane film.

4. The method of claim 1, wherein the joining includes:
silk screen printing an adhesive on a first surface of the separator layer and a second surface of the separator layer, the adhesive including an epoxy polyurethane two-component polymer; and
gluing the separator layer by the first surface to the anode layer and by the second surface to the cathode layer.

5. The method of claim 1, wherein:
disposing the anode layer includes one of silk screen printing the anode active mass to the first current collector or slot-die coating of the anode active mass on the first current collector; and
disposing the cathode layer includes one of silk screen printing the cathode active mass on the second current collector or slot-die coating the cathode active mass on the second current collector.

6. The method of claim 1, wherein:
the anode active mass comprises a mixture of:
a composite of thermoplastics;
a silver powder comprising silver particles of between 10⁻⁹ to 10⁻⁶ meters in a diameter; and
a potassium hydrogen carbonate of 10% by weight of the silver powder; and
the cathode active mass comprises a mixture of:
the composite of thermoplastics; and
a freshly prepared zinc hydroxide.

7. The method of claim 6, wherein the composite of thermoplastics includes a mixture of a low-density polyethylene and a polyethylene vinyl acetate.

8. The method of claim 1, wherein the electrolyte comprising a mixture of:
30-40% aqueous solution of potassium hydroxide;
1.5-2% aqueous solution of lithium hydroxide;
4-8% aqueous solution of potassium zincate; and
0.8-1.2% aqueous solution of modifying additives, the modifying additives including:
one or more of a monobasic organic acid, a dibasic organic acid, and a tribasic organic acid as anion donors; and
one or more complexones as cation electron acceptors.

9. The method of claim 1, further comprising while providing the second current collector, making one or more through holes in the second current collector to allow the electrolyte to penetrate to the separator layer; and
wherein impregnating the separator layer includes:
disposing the multi-layered structure into a surface-active agent (SAG) within a first vacuum container to allow the SAG to seal the one or more through holes in the second current collector;
disposing the multi-layered structure into the electrolyte within a second vacuum container until the SAG is evaporated and the separator layer is filled with the electrolyte; and
sealing the one or more through holes in the second current collector.
